(19) United States
(12) Patent Application Publication
(10) Pub. No.: US 2003/0112782 A1
(43) Pub. Date: Jun. 19, 2003

(54) Node, network and method for providing quality of service adjustments on a per-application basis

(76) Inventors: Jerry L. Mizell, Plano, TX (US); David J. Lauson, McKinney, TX (US); Peter W. Wenzel, Plano, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/025,543

(22) Filed: Dec. 18, 2001

(51) Int. Cl. H04Q 7/24

(52) U.S. Cl. 370/338; 370/349

(57) ABSTRACT

A method of processing data traffic in transit in a mobile telecommunication network comprising filtering a packet of data for an application associated therewith and applying a service marking to the packet dependent on the application associated with the packet is provided. A node of a mobile telecommunication network operable to deliver at least one packet to a mobile device serviced by the mobile telecommunication network comprising an interface to at least one other network node, and a table comprising an index including at least one key having a record associated therewith is provided, the node operable to interrogate the table with an identification of an application obtained from the packet. The service marking of a record associated with a key is returned to the node upon a match between the identification and the key.

### TECHNICAL FIELD OF THE INVENTION

This invention relates to mobile telecommunication systems and, more particularly, to a method, network and node for providing quality of service adjustments on a per-application basis.

### BACKGROUND OF THE INVENTION

The evolution of mobile telecommunication systems has brought about numerous offerings in the form of subscriber services. Early telecommunication systems, for example the advanced mobile phone system, were analog cellular systems and, consequently, were limited to providing basic voice services. However, modern telecommunication systems provide digital communications and are no longer confined to strictly voice services. Various data services are currently offered to cellular subscribers and include text messaging, and email as well as cellular Internet services presently being deployed. For example, general packet radio services (GPRS) were introduced in the Global System for Mobile communications (GSM) to more effectively utilize the radio spectrum for providing data oriented services. GPRS is a packet switched, rather than a circuit switched, data service and generally is more efficient than circuit switched data services because of deallocations of radio resources made during idle periods in a data communication session.

Various control nodes are typically distributed throughout the mobile telecommunication system. For example, mobile service switching centers (MSCs) are responsible for performing control and supervisory functions related to mobile connections to circuit switched networks, for example the public switched telephone network (PSTN). A gateway GPRS support node (GGSN) is typically accessed for connecting to a packet data network to access general packet radio services such as wireless Internet services. One or more Serving GPRS Support Nodes (SGSN) are included within the mobile telecommunication system for providing the mobile terminal access to the GPRS services, for example administering packet data protocol (PDP) sessions as well as performing managerial functions such as mobile terminal authentication, identification and IMEI interrogations. Thus, the GGSN provides an interface for the mobile telecommunications system to the data network while the SGSNs enable the mobile terminal to communicate with the GGSN and thus the packet data network over legacy mobile telecommunication system infrastructures.

Voice and data mobile telecommunication services are provided over an air interface between the mobile terminal and the mobile telecommunication system. One or more base transceiver stations (BTSs) engage an active mobile terminal over an air interface. The BTSs are controlled and supervised by base station controllers (BSCs). The BSCs are, in turn, managed by MSCs. Each BSC can control multiple BTSs. Similarly, each MSC can manage multiple BSCs. Each BSC and the BTSs controlled thereby comprise a base station subsystem (BSS). The MSC and associated managerial hardware and software comprise a switching subsystem (SS).

Mobile terminal voice service subscriptions typically levy a fee for a given quantity of network access time. Additional tariffs may then be implemented when the subscriber exceeds the allotted access time. Often, the network operators assign a home area within the mobile telecommunications network in which the access time may be used. When a subscriber travels outside the home area, additional tariffs may be levied, typically in the form of higher tariffs per unit of access time.

Network operators are finding a growing demand for data services such as GPRS. Various usage-based tariff schemes have been implemented for applying toll charges based on the volume of data usage by a mobile terminal. Much like common cellular voice subscription services that charge a flat fee for a particular number of minutes of cellular access, data usage tariffs commonly have fee structures based on the amount of data transmitted to or from the mobile terminal.

Different mobile subscribers may have different preferences with regard to the quality of service provisioned by the SGSN when accessing a data network. Quality of Service (QoS) triggers have been implemented to allow variations in billing fees associated with the quality of service a mobile terminal is provided with when accessing a data network. For example, the network operator may impose a higher tariff when a mobile terminal accesses a data network on full-rate equipment rather than half-rate equipment. A QoS trigger facilitates quality of service tariff changes during an active session with a data network by closing an open traffic volume container in a S-CDR when a QoS criteria threshold is met during the data session. For example, during an active session, full-rate channels in a BTS serving the mobile terminal may become unavailable. When a mobile terminal switches to a full-rate channel from a half-rate channel, a QoS trigger may close a current traffic volume container and open another traffic volume container. The network operator then may impose a higher tariff when a user accesses a data network over a full-rate channel.

Standards have been devised for implementation of differentiated classes of service, or differentiated services (DS), for providing quality of service in IP networks. Differentiated services allow control of network traffic such that certain types of traffic have a greater precedence assigned thereto and, accordingly, may receive preferential allocation of network resources when in transit across a network. Assignment of precedence to network traffic via implementation of differentiated services allows network traffic to be managed according to class of service specifications that define best-effort traffic control treatments. Differentiated services employ network policies, i.e. sets of statements that define how network resources are to be allocated among various network clients, for evaluating how a network packet is to be treated at a node of a network. Particularly, packets routed according to differentiated services specifications have per hop behaviors (PHBs) assigned thereto, for example a PHB specified by the type-of-service (TOS) field of an IPv4 packet header, a PHB specified by traffic class field of an IPv6 packet header, or by another designation in a packet that specifies a particular PHB.

Heretofore, however, a mobile network operator has not had the ability to impose variations in quality of service in an application-dependent manner. As GPRS services become more widely available and with the mobile networks becoming more ubiquitous with the Internet, numerous applications, such as email, Internet access, streaming media, etc., will be deployed by wireless carriers. It is apparent that a preference of quality of service may be desired amongst the various services by wireless subscribers. Thus, it may be seen from the foregoing that a system and method providing differentiated service classifications on a per-application basis in a mobile telecommunication system is desired.

### SUMMARY OF THE INVENTION

In accordance with an embodiment of the present invention, a method of processing data traffic in transit in a mobile telecommunication network comprising filtering a packet of data for an application associated therewith and applying a service marking to the packet dependent on the application associated with the packet is provided.

In accordance with another embodiment of the present invention, a node of a mobile telecommunication network operable to deliver at least one packet to a mobile device serviced by the mobile telecommunication network comprising an interface to at least one other network node, and a table comprising an index including at least one key having a record associated therewith is provided. Each record includes a service marking therein and the node is operable to interrogate the table with an identification of an application obtained from the packet. The service marking of a record associated with a key is returned to the node upon a match between the identification and the key.

In accordance with yet another embodiment of the present invention, a mobile telecommunication network operable to provide data services to a mobile terminal serviced thereby comprising a service node including a table comprising one or more keys and at least one record having a service marking therein and associated with each of the one or more keys having a value indicative of an application is provided. The service node is operable to receive a packet and determine an application associated therewith and to interrogate the table with a query value indicative of the application. A service marking is returned upon matching the query value with a first key value and is written into a field of the packet.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a mobile telecommunications system on which the present invention may be implemented for providing quality of service adjustments on a per-application basis according to an embodiment of the invention;

FIG. 2 illustrates a network node that provides quality of service adjustments on a per-application basis according to an embodiment of the invention; and

FIG. 3 illustrates a table that may be interrogated by a node to provide service markings to packets that facilitates quality of service adjustments on a per-application basis according to an embodiment of the invention.

### DETAILED DESCRIPTION OF THE DRAWINGS

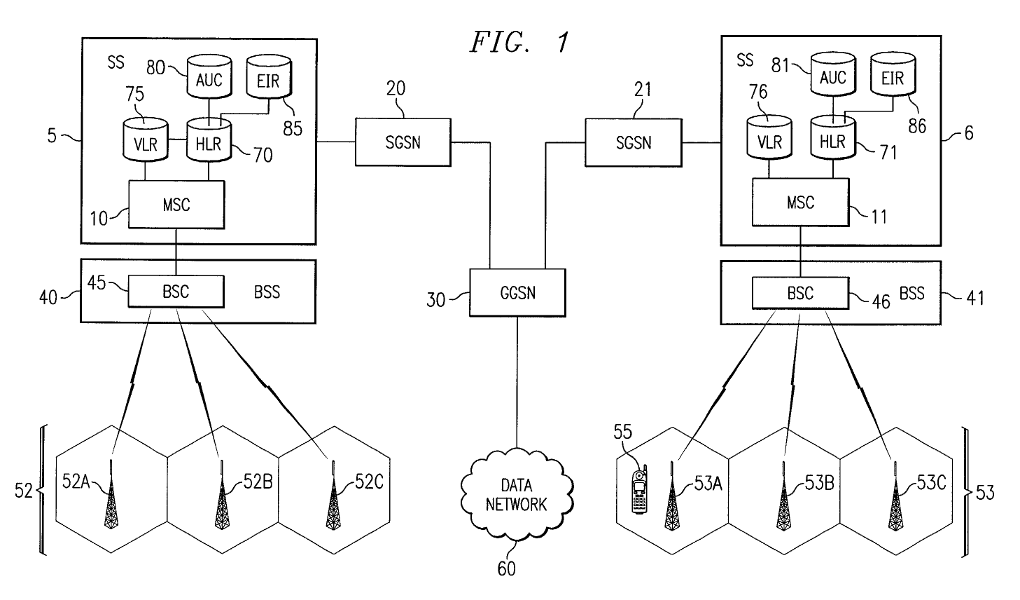

The preferred embodiment of the present invention and its advantages are best understood by referring to FIGS. 1 through 3 of the drawings, like numerals being used for like and corresponding parts of the various drawings.

In FIG. 1, there is illustrated a mobile telecommunications system (MTS) 100 in which the present invention may be implemented. The exemplary mobile telecommunication system 100 is described according to the general infrastructure and nomenclature of the Global System for Mobile communications (GSM) standards and General Packet Radio Services (GPRS) although the present invention is not limited to application in such a system. Cellular telecommunication services are provided to one or more mobile terminals (MTs) 55. The MTS 100 generally includes one or more switching systems (SSs) 5-6 and base station subsystems (BSSs) 40-41. The mobile terminal 55 can take on various forms other than a traditional cellular telephone, for example mobile terminal 55 may be a laptop computer with a wireless modem capable of mobile terminations, a wireless personal digital assistant, etc. Mobile terminal 55 communicates directly with one or more base transceiver stations (BTSs) 52A-52C and 53A-53C that operate under coordination of a base station controller (BSC) 45-46 and that collectively therewith comprise a respective base station subsystem BSS 40-41. Each BSS, for example BSS 40, will typically include one or more geographically diverse BTSs, for example BTSs 52A-52C. A group of BTSs, for example one of a BTS group 52-53, is managed by a base station controller (BSC) 45-46, also referred to as a radio network controller, that, in turn, communicates with, and is controlled by, a respective mobile services switching center (MSC) 10-11 included within a switching system (SS) 56. Each individual BTS 52A-52C and 53A-53C defines a radio cell operating on a set of radio channels thereby providing service to one or more mobile terminals (MTs) 55. Accordingly, each BSC 45-46 will have a number of cells corresponding to the respective number of BTSs 52A-52C and 53A-53C controlled thereby.

The switching system 5-6 contains a number of functional units implemented in various hardware and software. Generally, each SS 5-6 respectively contains an MSC 10-11, a Visitor Location Register (VLR) 75-76, a Home Location Register (HLR) 70-71, an Authentication Center 81-82, and an Equipment Identity Register 85-86. Mobile terminal 55 operable within the MTS 100 has a register designated as a home register. In the present illustration, and in the examples provided hereinbelow, HLR 71 represents the home register of the mobile terminal 55. HLR 71 is a database containing profiles of mobile terminals having the HLR 71 designated as the home register. The information contained within the subscriber profile in HLR 71 includes various subscriber information, for example authentication parameters such as an international mobile station equipment identity (IMEI) that may be compared with the IMEI stored in a subscriber identity module (SIM) of MT 55 for authentication purposes, an electronic serial number (ESN) and an authentication capability parameter as well as subscription service parameters such as an access point name (APN) that defines the services included in the subscription. Additionally, a subscriber profile of MT 55 in HLR 71 contains data related to the current, or last known, location of MT 55 within MTS 100, for example a location area identifier. The location data contained within HLR 71 associated with MT 55 is dynamic in nature, that is it changes as MT 55 moves throughout MTS 100. It should be understood that each MSC 10-11 may, and typically does, control more than one BSC 45-46. In FIG. 1, only one respective BSC 45-46 is shown controlled by MSC 10-11 to simplify discussion of the invention.

VLR 75-76 is a database that contains information about all MTs 55 currently being serviced by MSC 10-11 associated therewith. For example, VLR 76 will include information relating to each MT being serviced by MSC 11 and thus includes information associated with all MTs currently serviced by BTSs 53A-53C that are controlled by the associated BSC 46. When MT 55 enters a cell coverage area of a BTS controlled by another MSC, for example when MT 55 roams into the coverage area provided by BTS 52C, VLR 75 of SS 5 associated with BTS 52C will interrogate HLR 71 for subscriber information relating to MT 55. This information is then transferred to VLR 75. At the same time, VLR 75 transmits location information to HLR 71 indicating the new position of MT 55. The HLR profile associated with MT 55 is then updated to properly indicate the position of MT 55. This location information is generally limited to a location area identifier. The information transmitted to VLR 75 associated with a roaming MT 55 generally allows for call setups and processing for MT 55 without further interrogation of HLR 71, authentication and subscription service parameters of MT 55. Thus, when MT 55 attempts to perform or receive a call, for example a data call, SS 5 has the requisite information for performing the setup and switching functions to properly service MT 55. Additionally, VLR 75 will typically include more precise location information on MT 55 than HLR 71, for example VLR 75 may contain a BSC identifier indicating the particular BSC servicing MT 55. VLRs 75-76 may assign a temporary mobile subscriber identifier (TMSI) to MT 55 that is relevant only in the area serviced by the SS maintaining that particular VLR. When MT 55 leaves a visited service area of an MSC, the VLR information on MT 55 therein may be destroyed.

Each SS 5-6 may also include an authentication center (AUC) 81-82 connected to HLR 70-71 of the respective SS 5-6. AUC 81-82 provides authentication parameters to HLR 70-71 for authenticating MT 55-56. AUC 81-82 may also generate ciphering keys used for securing communications with MT 55. Additionally, each SS 5-6 may also include an equipment identity register (EIR) 85-86 database that contains the international mobile station equipment identity used to uniquely identify MT 55. EIR 85-86 is used to validate MT 55 requesting service in MTS 100.

General packet radio services (GPRS) may be provided in MTS 100 by including GPRS support nodes within MTS 100. GPRS support nodes include one or more gateway GPRS support (GGSN) nodes 30 and one or more servicing GPRS support (SGSN) nodes 20-21. SGSN 20-21 administers packet data protocol (PDP) sessions with MT 55 and is responsible for packet routing and delivery of data packets to and from MT 55 within a service area of MTS 100 assigned thereto. Additionally, SGSNs 20-21 are responsible for performing various mobility and managerial functions, MT 55 attach and detach procedures, MT 55 authentication, link management and other functions. SGSNs 20-21 respectively maintain a location register for facilitating execution of the various SGSN procedures. An SGSN location register maintains various location information, such as the current cell provided by BTS 52A-52C and 53A-53C in which MT 55 is located, identification of the current VLR 75-76 established for MT 55, and user profile information such as IMSI and packet data network addresses assigned to MT 55. An SGSN location register maintains location information for each MT 55 serviced thereby.

A gateway GPRS support node (GGSN) 30 is typically included in MTS 100 for connecting to a packet data network 60 to access general packet radio services such as wireless Internet services. GGSN 30 provides an interface between mobile telecommunications system 100 and packet data network 60, such as the Internet. Accordingly, GGSN 30 converts packets received by SGSN 20-21 connected thereto from the format utilized by MTS 100 data service, e.g. GPRS, to an appropriate PDP utilized by external data network 60, e.g. IP, X.25, etc, prior to transmitting data received from MT 55 to data network 60. Likewise, GGSN 30 converts data received from data network 60 addressed to MT 55 from the PDP utilized by data network 60 to the data protocol supported by MTS 100. Additionally, GGSN converts addresses of data received by data network 60 destined for MT 55 from the address format of data network 60, e.g. from an IP address, to an appropriate address for MTS 100, e.g. a GSM address. The readdressed and reformatted data packet(s) are then forwarded by GGSN 30 to SGSN 21 currently servicing MT 55. GGSN 30 may also perform various managerial functions such as authentication and charging functions.

A GPRS-capable MT 55 must first perform an attach procedure prior to accessing a packet data network. In general terms, the attach procedure is initiated by transmission of an Attach Request message to SGSN 21 servicing MT 55. In the present illustrative example, MT 55 is currently located within a cell provided by BSS 41. SGSN 21 is connected to BSS 41 by a communication channel and thus is responsible for providing GPRS services to MT 55. SGSN 21 then identifies and authenticates MT 55 after which an Update Location message is transmitted to HLR 71. Authentication of MT 55 may include interrogation by SGSN 21 of various modules in SS 6 maintaining HLR 71 assigned to MT 55, for example SGSN 21 may interrogate AUC 82 and/or EIR 86. Upon successful authentication of MT 55 by SGSN 21, the subscriber profile (or a portion thereof) maintained in HLR 71 is copied to SGSN 21 and assigns a packet temporary mobile subscriber identify (P-TMSI) is assigned to MT 55. A location update may be provided to HLR 71 by SGSN 21 and an acknowledgment of the location update may then be transmitted to SGSN 21 by HLR 71 as well.

To engage in packet communications, an attached MT 55 must first perform an activation procedure to obtain an address used by data network 60, e.g. an IP address. For each data session established between MT 55 and data network 60, a record describing the session, such as PDP type, e.g. IPv4, IPv6, etc., the PDP address assigned to MT 55, a requested quality of service, the address of GGSN 30 providing the interface between MTS 100 and data network 60 for MT 55, and/or other information, is made and is commonly referred to as a context. Modem mobile devices may maintain multiple simultaneous contexts and each context may be stored in MT 55, SGSN 21, and GGSN 30. Generally, an Activation Request message is transmitted from MT 55 to the currently servicing SGSN 21. SGSN 21 then contacts GGSN 30 and requests a PDP activation. GGSN 30 maintains a PDP context table and records the address of SGSN 21 servicing MT 55 so that packet data from data network 60 can be appropriately routed to MT 55 via SGSN 21. GGSN 30 replies to SGSN 21 with a PDP context creation confirmation and SGSN 21 updates a PDP context table maintained thereby. The PDP context creation confirmation may include the PDP address (in the event dynamic addresses are provided by GGSN 30). MT 55 is then informed of the activated PDP context by a confirmation message transmitted thereto by SGSN 21. GGSN 30 will then update the SGSN address recorded in the PDP context table stored thereby whenever MT 55 roams into a cell provided by a BTS serviced by another SGSN, for example when MT 55 roams into the cell provided by BTS 52C serviced by SGSN 20. A billing node, for example a charging gateway function 95, may be included for receiving usage statistics, for example usage data in the form of M-CDRs, S-CDRs, and/or gateway GPRS support node-call detail records (G-CDRs) on individual mobile subscribers to facilitate appropriate billing thereof.

The present invention provides a technique for providing differentiated services on a per application basis in a mobile telecommunication network. As mentioned hereinabove, differentiated service may be indicated by a bit pattern in each packet delivered, such as a designated bit pattern in the traffic class octet of an IPv6 header. Per hop behaviors are specified by the traffic class octet and the packet is treated accordingly in transit across the subscriber's carrier network. A carrier edge device, such as a router on the subscribers' carrier network, is preferably responsible for denoting the differentiated service requested by the subscriber by, for example, marking the traffic class octet of an IPv6 header received from data network 60 prior to forwarding the packet across MTS 100 to MT 55. MTS 100 will then transfer the packet according to per hop behaviors consistent with the requested class of service. The packet is then delivered to GGSN 30 servicing MT 55, the PDP address is resolved to an appropriate address for routing across MTS 100 thereby, and GGSN 30 forwards the packet to SGSN 21 servicing MT 55 where it is forwarded to the appropriate BSS and delivered to MT 55 via a radio channel.

As aforedescribed, GGSN 30 provides an interface between mobile telecommunications network 100 and public data network 60. GGSN 30 may be provided with a filtering mechanism, e.g. software filters and/or hardware filters, that determine the application, for example a wireless email, Internet browsing, streaming media, etc., associated with packets of a particular PDP context received thereby. GGSN preferably maintains a table for cross-referencing the determined application with a differentiated service marking such as a DS codepoint. Accordingly, each packet received by GGSN 30 and having an application determined therefor may have a differentiated service marking written into the packet thereby providing quality of service dependent on a particular application.

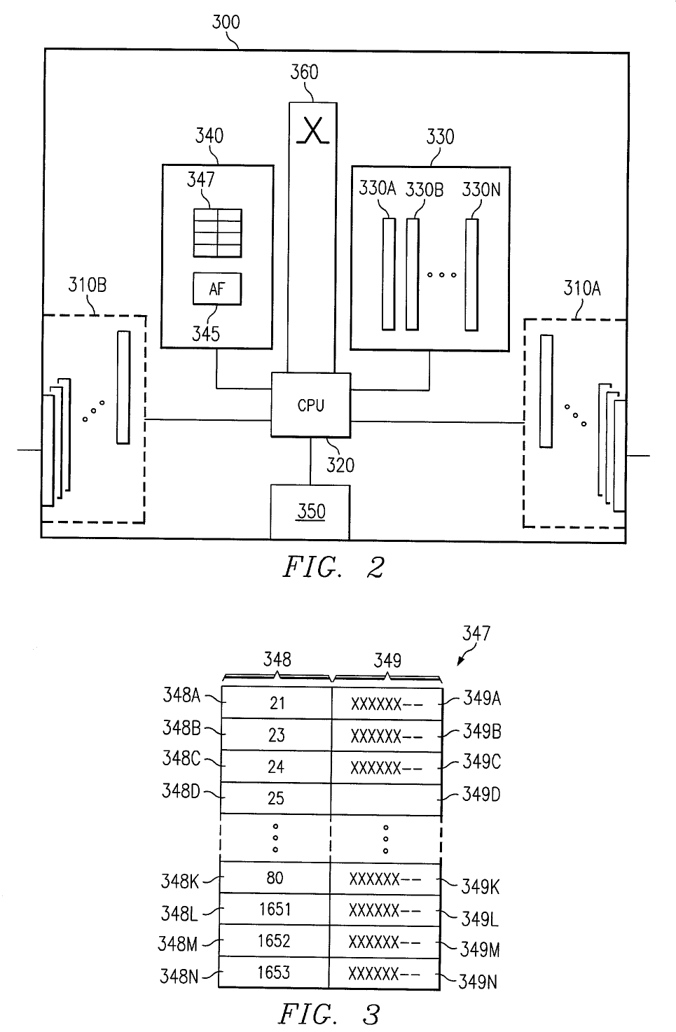

In FIG. 2, the is shown a simplified illustration of a network node 300 that may be implemented as a GGSN 30, an access router, or another network node according to an embodiment of the invention. Node 300 may include one or more interface bays 310A and 310B each including one or more interface boards, such as El, Ti, ATM, Ethernet or other network interface boards. A central processing unit 320, such as a SPARC microprocessor, a PowerPC microprocessor, and/or another central processing unit, may be included in node 300 and may be coupled to interface bays 310A and 310B, a general processing bay 330 that may include one or more general processing boards 330A-330N, a memory bank 340, a power source 350 that may be coupled to any of the subsystems of node 300, a switching system 360, and/or another core and/or GPRS support node subsystem. One or more general processing boards 330A-330N may be responsible for servicing core functions, such as execution of node management software, providing interfaces for various protocols for allowing communications with external nodes, execution of operation and maintenance applications and/or other core applications. Additionally, one or more general processing boards 330A-330N may support data application subsystems, such as context control subsystems that manage individual data sessions, a visitor register subsystem that incorporates VLR functionality into a GPRS support node, a network access subsystem, and/or other subsystems that facilitate access and provisioning of data communications with mobile devices.

An application filter 345 is executable by node 300 in an embodiment of the invention. Application filter 345 may be maintained in memory bay 340 and retrievable and executable by central processing unit 320. Alternatively, application filter 345 may be maintained on one or more general processing boards 330A-330N and executable therefrom. In general, application filter 345 filters packets received by node 300 for data indicative of the application that will process the packet at the destination device. Preferably, filtering performed by application filter 345 includes analyzing a received packet for an encapsulated port number(s) in a transport layer header of the packet, for example a destination port number of a TCP header of the received packet. The port number recovered from the analyzed packet may then be used to interrogate a table 347 to determine a desired differentiated service for the evaluated application. Table 347 may be maintained in memory bay 340 or, alternatively, within one or more general processing boards 330A-330N. Table 347 preferably maintains cross-reference relationships between port numbers and differentiated service marking. Various port numbers may be defined as keys and the collection of valid port numbers accordingly defines the table 347 index. Interrogation of table 347 with a port number having a key field corresponding thereto results in recovery of an associated differentiated service marking. Node 300 may then write the recovered differentiated service marking into an appropriate header field, for example the type of service octet of an IPv4 header, the class of service of an IPv6 packet header, or other field of a packet header that may be read by routing and forwarding equipment of a network. Thus, quality of service, as provided by hierarchical treatment processes provided by various networking equipment while the packet is in transit, is provided on a per-application basis as determined by the port number at node 300.

In FIG. 3, there is illustrated an embodiment of table 347 described with reference to FIG. 2. Index 348 includes one or more keys 348A-348N having values assigned thereto of well-known port numbers. For example, key 348A has a value of 21 assigned thereto—a port number commonly assigned to FTP applications. Other exemplary well-known port numbers include 23 (Telnet), 24-25 (mail), 80 (HTTP), 1651 (conference audio), 1652 (conference video), and 1653 (conference data) each respectively assigned to keys 348B-348N. The values assigned to keys 348A-348N are illustrative only and, in practice, hundreds or thousands of such keys may be included in table 347.

Each key 348A-348N indexes a respective differentiated service marking field 349A-349N. The differentiated service field is presently defined to supersede the IPv4 type of service octet and the IPv6 service class octet and, accordingly, the values assigned to differentiated service marking fields 349A-349N preferably are of the format XXXXXX—, where X may be set to 0 or 1 and the two least significant bits are ignored by a differentiated service compliant node. Values assigned to DS marking may then be set by a network operator in accordance with published standards or local network preferences. Upon successful identification of a destination application, that is by identification of a destination port number in node 300, and a successful interrogation of table 347, the associated DS marking obtained by interrogation of table 347 may be written into the analyzed packet prior to forwarding the packet to network 100. Accordingly, any DS compliant routers encountering the packet will provide per hop behaviors thereto in response to reading the DS field of the packet. Thus, per hop behaviors are applied to packets on a per-application basis.

The exemplary mobile telecommunication system has been described according to the general infrastructure and nomenclature of the Global System for Mobile communications (GSM) standards although the present invention is not limited to application in such a system but was only chosen for facilitating discussion of the invention. For example, the present invention may just as effectively be implemented on a Universal Mobile Telecommunications System (UMTS). Furthermore, the attach procedures described herein have been described, in general, in relation to packet data protocol packet attach procedures. The packet data protocol attach procedures for accessing GPRS in a GSM architecture require a GPRS operable mobile terminal. However, the present invention is not limited to such attach procedures and the descriptions thereof are only intended to be illustrative. For example, non-GPRS mobile terminals could be accommodated by accessing a data network implementing the present invention by IMSI attach procedures as is understood in the art.

Although one or more embodiments of the method and apparatus of the present invention has been illustrated in the accompanying drawings and described above, it will be understood that the invention is not limited to the embodiments disclosed, but is capable of numerous rearrangements, modifications and substitutions without departing from the spirit of the invention as set forth and defined by the following claims.

What is claimed is:

1. A method of processing data traffic in transit in a mobile telecommunication network, comprising:
filtering a packet of data for an application associated therewith; and
applying a service marking to the packet dependent on the application associated with the packet.

2. The method according to claim 1, wherein filtering a packet of data for an application associated therewith further comprises reading a port from the packet and determining the application from the read port.

3. The method according to claim 2, wherein determining the application from the read port further comprises:
interrogating a table with the read port, the table including an index of at least one port, each of the at least one port comprises a key of the table, a record having a service marking respectively associated with each key;
determining the read port has a match with a first key of the table; and
returning a first service marking included in a record associated with the first key.

4. The method according to claim 3, further comprising writing the first service marking into a field of the packet.

5. The method according to claim 3, wherein the service marking in the record is a differentiated service codepoint.

6. A node of a mobile telecommunication network operable to deliver at least one packet to a mobile device serviced by the mobile telecommunication network, comprising:
an interface to at least one other network node; and
a table comprising an index including at least one key, each key having a record associated therewith, each record having a service marking therein, the node operable to interrogate the table with an identification of an application obtained from the packet, the service marking returned to the node upon a match between the identification and a key.

7. The node according to claim 6, wherein the node is an access router that interfaces the mobile telecommunication network with an external network.

8. The node according to claim 6, wherein the node writes the returned service marking into a field of the packet.

9. The node according to claim 8, wherein the field is a differentiated services field of a transport layer header encapsulated in the packet.

10. The node according to claim 6, wherein the service marking is a differentiated services codepoint.

11. The node according to claim 6, wherein the node is a general packet radio services support node.

12. A mobile telecommunication network operable to provide data services to a mobile terminal serviced thereby, the mobile telecommunications network comprising:
a first service node including a table comprising one or more keys and at least one record associated with each of the one or more keys having a value indicative of an application, each of the one or more records having a service marking stored therein;
a base station subsystem operable to transmit data to the first service node and receive data from the first service node; and
at least one base transceiver station operable to provide radio frequency links to the mobile device, the first service node operable to receive a first packet and determine an application associated therewith, the first service node operable to interrogate the table with a query value indicative of the application, a service marking being returned upon matching the query value with a first key value, the service marking maintained in a record associated with the first key value, the node operable to write the service marking into a field of the packet, the node operable to transmit the packet across the telecommunication network.

13. The telecommunication network according to claim 12, wherein each value of the one or more keys is a port number.

14. The telecommunication network according to claim 12, wherein each service marking is a differentiated services codepoint.

15. The telecommunication network according to claim 12, wherein the service node further comprises a memory bank, a central processing unit, and a filter, a port number field of the packet read by the filter, the value of the port number read used by the node to interrogate the table index.

16. The telecommunication network according to claim 12, wherein the service node further comprises a processing card, the processing card including a memory module and a processing unit, a filter maintained in the memory module and executable by the processing unit, the filter operable to analyze the packet and determine the value indicative of the application.
